(19) United States
(12) Patent Application Publication
(10) Pub. No.: US 2018/0255341 A1
(43) Pub. Date: Sep. 6, 2018

(54) Method and Apparatus for Video Playback

(71) Applicants: LE HOLDINGS (BEIJING) CO., LTD., Beijing (CN); LE SHI INTERNET INFORMATION & TECHNOLOGY CORP. BEIJING, Beijing (CN)

(72) Inventors: Shili DENG, BEIJING (CN); Shibin LI, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/119,832

(22) PCT Filed: May 26, 2016
(86) PCT No.: PCT/CN2016/083547

§ 371 Date: Aug. 18, 2016

(30) Foreign Application Priority Data
Nov. 25, 2015 (CN) 201510834350.2

(51) Int. Cl. H04N 21/431; H04N 21/472; G06F 17/30; G06F 3/0484; G06F 3/0488

(52) U.S. Cl. CPC H04N 21/431; H04N 21/47202; G06F 3/0488; G06F 3/04842; G06F 17/30849

(57) ABSTRACT

Disclosed is a method for video playback, comprising: obtaining and displaying a video preview interface; sensing a first touch event occurred on one preview picture in the video preview interface; displaying a detailed preview picture of a video corresponding to the preview picture if the first touch event is a first preset gesture; sensing a second touch event switched from the first preset gesture; and, playing the video corresponding to the preview picture if the second touch event is a second preset gesture. The disclosure also provides an apparatus for video playback.

### CROSS-REFERENCE TO RELATED APPLICATIONS

This application is a continuation of International Application No. PCT/CN2016/083547, filed on May 26, 2016, which is based upon and claims priority to Chinese Patent Application No. 2015108343502, filed on Nov. 25, 2015, the entire contents of which are incorporated herein by reference.

### TECHNICAL FIELD

The present disclosure relates to electronic device control field, and in particular to a method and apparatus for video playback.

### BACKGROUND

With rapid development and more popularity of intelligent electronic devices, users of intelligent electronic devices are increasingly intended to watch their interested films, televisions, entertainments, etc., via video software.

In the existing video software, in order to facilitate a user to find a video of interest, normally a preview interface which is constituted by video snapshots would be generated, so that the user can know about the general content of the video based on the video snapshots. In order to display a plurality of video snapshots on the screen, the video snapshot thumbnails are usually shown in the preview interface. The user can click on a video snapshot thumbnail to view an enlarged picture of the video snapshot. If the user is interested, he/she can quit the enlarged picture and turn to click on a play button of the video corresponding to the enlarged picture to enter a video player for preview and playback of the video. Thus, when the user find his/her interested video, he/she has to close the enlarged picture of the video snapshot and turn to click on the play button to watch the video. This operation mode of preview and playback of video is redundant for operating procedure and inefficient.

### SUMMARY

In view of this, an object of an embodiment of the present disclosure is to propose a method and apparatus for video playback so as to simplify the operation of the user's video playback and improve fluency of the user's experience.

A method for video playback provided by an embodiment of the present disclosure based on the object comprises:
obtaining and displaying a video preview interface;
sensing a first touch event occurred on one preview picture in the video preview interface;
displaying a detailed preview picture of the video corresponding to the preview picture if the first touch event is a first preset gesture;
sensing a second touch event switched from the first preset gesture; and
playing the video corresponding to the preview picture if the second touch event is a second preset gesture.

In some preferred embodiments, the first preset gesture is a light pressing and the second preset gesture is a heavy pressing.

In some preferred embodiments, further comprising a step of distinguishing between the light pressing and the heavy pressing, wherein the step comprises:
setting a first pressure threshold, such that the touch event is determined as the heavy pressing if the touch pressure is greater than the first pressure threshold, and such that the touch event is determined as the light pressing if the touch pressure is less than or equal to the first pressure threshold; or
setting a first touch area threshold, and such that the touch event is determined as the light pressing if the touch area is less than or equal to the first touch area threshold, and such that the touch event is determined as the heavy pressing if the touch area is larger than the first touch area threshold; or
determining based on the combination of the touch pressure and the touch area, such that if the touch pressure is less than or equal to the first pressure threshold and/or the touch area is less than or equal to the first touch area threshold, the touch event is determined as the light pressing, and such that if the touch pressure is greater than the first pressure threshold and/or the touch area is larger than the first touch area threshold, the touch event is determined as the heavy pressing.

In some preferred embodiments, after sensing a second touch event switched from the first preset gesture, the method further comprises:
closing the detailed preview picture and displaying the video preview interface if the second touch event is a releasing.
   In some preferred embodiments, after sensing a second touch event switched from the first preset gesture, the method further comprises:
closing the detailed preview picture and deleting the touched preview picture from the video preview interface if the second touch event is a swiping to the left;
extracting a preview picture of a new video from video sources not shown in the video preview interface and filling the preview picture of the new video into the position of the deleted preview picture; and
displaying the new video preview interface.

In some preferred embodiments, the detailed preview picture is an enlarged picture of the preview picture, an enlarged video preview gif picture of the video corresponding to the preview picture, or an array of multiple preview pictures of key frames which are extracted by playing order of the video corresponding to the preview picture.

In some preferred embodiments, after sensing a first touch event occurred on one preview picture in the video preview interface, the method further comprises:
displaying the enlarged picture of the preview picture or the array of multiple preview pictures of key frames which are extracted by playing order of the video corresponding to the preview picture if the first touch event is a tapping;
after a first time interval, closing the enlarged picture of the preview picture or the array of multiple preview pictures of key frames which are extracted by playing order of the video corresponding to the preview picture; and
continuing to display the video preview interface.
   In some preferred embodiments, further comprising a step of distinguishing between the light pressing and the tapping, wherein the step comprises:
setting a second pressure threshold, such that the touch event is determined as the light pressing if the touch pressure is greater than the second pressure threshold and less than the first pressure threshold, and such that the touch event is determined as the tapping if the touch pressure is less than or equal to the second pressure threshold; or
setting a second touch area threshold, such that the touch event is determined as the light pressing if the touch area is larger than the second touch area threshold and less than or equal to the first touch area threshold, and such that the touch event is determined as the tapping if the touch area is less than or equal to the second touch area threshold; or
determining based on the combination of the touch pressure and the touch area, such that if the touch pressure is less than or equal to the second pressure threshold, and/or the touch area is less than or equal to the second touch area threshold, the touch event is determined as the tapping, and such that if the touch pressure is greater than the second pressure threshold and less than or equal to the first pressure threshold, and/or the touch area is larger than the second touch area threshold and less than or equal to the first touch area threshold, the touch event is determined as the light pressing.

In some preferred embodiments, a logo for guiding the user to click on such position is provided at one of the four corners of each preview picture in the video preview interface.

In another aspect of an embodiment of the present disclosure, it also provides an apparatus for video playback, comprises:
a preview interface obtaining module, configured to obtain a video preview interface according to a preview instruction;
a touch event sensing module, configured to sense an occurrence of a first touch event and an occurrence of a second touch event on one preview picture in the video preview interface;
a touch event determining module, configured to determine whether the first touch event is a first preset gesture, and send an instruction of displaying a detailed preview picture to the display module if it is a first preset gesture, and configured to determine whether the second touch event is a second preset gesture, and send an instruction of playing video to the display module if it is a second preset gesture; and
a display module, configured to display the video preview interface, the detailed preview picture or the video.

In some preferred embodiments, the first preset gesture is the light pressing and the second preset gesture is the heavy pressing.

In some preferred embodiments, the touch event determining module is further configured to distinguish between the light pressing and the heavy pressing, comprising:
setting a first pressure threshold, such that the touch event is determined as the heavy pressing if the touch pressure is greater than the first pressure threshold, and such that the touch event is determined as the light pressing if the touch pressure is less than or equal to the first pressure threshold; or
setting a first touch area threshold, such that the touch event is determined as the light pressing if the touch area is less than or equal to the first touch area threshold, and such that the touch event is determined as the heavy pressing if the touch area is larger than the first touch area threshold; or
determining based on the combination of the touch pressure and the touch area, such that if the touch pressure is less than or equal to the first pressure threshold, and/or the touch area is less than or equal to the first touch area threshold, the touch event is determined as the light pressing, and such that if the touch pressure is greater than the first pressure threshold, and/or the touch area is larger than the first touch area threshold, the touch event is determined as the heavy pressing.

In some preferred embodiments, the touch event determining module is further configured to determine whether the second touch event is a releasing, and send an instruction of closing detailed preview picture to the display module if it is a releasing; and the display module is further configured to close the preview picture and display the video preview interface according to the instruction of closing detailed preview picture.

In some preferred embodiments, the touch event determining module is further configured to determine whether the second touch event is a swiping to the left, send an instruction of deleting preview picture to the display module if it is a swiping to the left; and wherein the display module is further configured to delete the touched preview picture from the video preview interface, extract a preview picture of a new video from video sources not shown in the video preview interface, fill the preview picture of the new video into the position of the deleted preview picture, and display the new video preview interface according to the instruction of deleting preview picture.

In some preferred embodiments, the detailed preview picture is the enlarged picture of the preview picture, an enlarged video preview gif picture of the video corresponding to the preview picture, or an array of multiple preview pictures of key frames which are extracted by playing order of the video corresponding to the preview picture.

In some preferred embodiments, the touch event determining module is further configured to determine whether the first touch event is tapping, and send enlarged picture preview instruction or array preview instruction to the display module if it is tapping; and the display module is further configured to display the enlarged picture of the preview picture or the array of multiple preview pictures of key frames which are extracted by playing order of the video corresponding to the preview picture; after a first time interval, close the enlarged picture of the preview picture or the array of multiple preview pictures of key frames which are extracted by playing order of the video corresponding to the preview picture; and continue to display the video preview interface by the enlarged picture preview instruction or the array preview instruction.

In some preferred embodiments, the touch event determining module is further configured to distinguish between the light pressing and the tapping, comprising:
setting a second pressure threshold, such that the touch event is determined as the light pressing if the touch pressure is greater than the second pressure threshold and less than the first pressure threshold, and such that the touch event is determined as the tapping if the touch pressure is less than or equal to the second pressure threshold; or
setting a second touch area threshold, such that the touch event is determined as the light pressing if the touch area is larger than the second touch area threshold and less than or equal to the first touch area threshold, and such that the touch event is determined as the tapping if the touch area is less than or equal to the second touch area threshold; or
determining based on the combination of the touch pressure and the touch area, such that if the touch pressure is less than or equal to the second pressure threshold, and/or the touch area is less than or equal to the second touch area threshold, the touch event is determined as the tapping, and such that if the touch pressure is greater than the second pressure threshold and less than or equal to the first pressure threshold, and/or the touch area is larger than the second touch area threshold and less than or equal to the first touch area threshold, the touch event is determined as the light pressing.

In some preferred embodiments, the touch event determining module is further such that provide a logo for guiding the user to click on such position at one of the four corners of each preview picture in the video preview interface.

In yet another aspect of an embodiment of the present disclosure, it further provides an apparatus, comprising:
a touch screen, configured to receive a touch signal;
one or more processor(s); and
a memory, configured to store one or more operating instruction(s);

wherein the one or more processor(s) is/are configured to obtain operation instruction from the memory and execute(s) the steps of:
obtaining and displaying a video preview interface;
sensing a first touch event occurred on one preview picture in the video preview interface;
displaying a detailed preview picture of the video corresponding to the preview picture if the first touch event is the first preset gesture;
sensing a second touch event switched from the first preset gesture; and
playing a video corresponding to the preview picture if the second touch event is the second preset gesture.

In some embodiments, the first preset gesture is light pressing and the second preset gesture is heavy pressing.

In some embodiments, the processor is further configured to execute the steps of:
setting a first pressure threshold, such that the touch event is determined as the heavy pressing if the touch pressure is greater than the first pressure threshold, and, such that the touch event is determined as the light pressing if the touch pressure is less than or equal to the first touch pressure threshold; or
setting a first touch area threshold, such that the touch event is determined as the light pressing if the touch area is less than or equal to the first touch area threshold, and such that the touch event is determined as the heavy pressing if the touch area is larger than the first touch area threshold; or
determining based on the combination of the touch pressure and the touch area, such that if the touch pressure is less than or equal to the first pressure threshold, and/or the touch area is less than or equal to the first touch area threshold, the touch event is determined as the light pressing, and such that if the touch pressure is greater than the first pressure threshold, and/or the touch area is larger than the first touch area threshold, the touch event is determined as the heavy pressing.

In some embodiments, the processor is further configured to execute the steps of:
closing the detailed preview picture and displaying the video preview interface if the second touch event is a releasing.

In some embodiments, the processor is further configured to execute the steps of:
closing the detailed preview picture and deleting the touched preview picture from the video preview interface if the second touch event is a swiping to the left;
extracting a preview picture of a new video from video sources not shown in the video preview interface and filling the preview picture of the new video into the position of the deleted preview picture; and
displaying the new video preview interface.

In some embodiments, the detailed preview picture is an enlarged picture of the preview picture, an enlarged video preview gif picture of the video corresponding to the preview picture, or an array of multiple preview pictures of key frames which are extracted by playing order of the video corresponding to the preview picture.

In some embodiments, the processor is further configured to execute the steps of:
displaying the enlarged picture of the preview picture or the array of multiple preview pictures of key frames which are extracted by playing order of the video corresponding to the preview picture if the first touch event is tapping;
after a first time interval, closing the enlarged picture of the preview picture or the array of multiple preview pictures of key frames which are extracted by playing order of the video corresponding to the preview picture; and
continuing to display the video preview interface.

In some embodiments, the processor is further configured to execute the steps of:
setting a second pressure threshold, such that the touch event is determined as the light pressing if the touch pressure is greater than the second pressure threshold and less than the first pressure threshold, and such that the touch event is determined as the tapping if the touch pressure is less than or equal to the second pressure threshold; or
setting a second touch area threshold, such that the touch event is determined as the light pressing if the touch area is larger than the second touch area threshold and less than or equal to the first touch area threshold, and such that the touch event is determined as the tapping if the touch area is less than or equal to the second touch area threshold; or
determining based on the combination of the touch pressure and the touch area, such that if the touch pressure is less than or equal to the second pressure threshold, and/or the touch area is less than or equal to the second touch area threshold, the touch event is determined as the tapping, and such that if the touch pressure is greater than the second pressure threshold and less than or equal to the first pressure threshold, and/or the touch area is larger than the second touch area threshold and less than or equal to the first touch area threshold, the touch event is determined as the light pressing.

In some embodiments, a logo for guiding the user to click on such position is provided at one of the four corners of each preview picture in the video preview interface.

As can be seen from the above, the method and apparatus for video playback provided by the embodiments of the present disclosure, through applying to the first preset gesture on the preview picture, enables users to view the detailed preview picture for more information about the video in order to determine whether users are interested in the video. When users make sure they're interested, users switch to a second preset gesture from the first preset gesture to start playing the video directly. The method can allow the users to determine whether they are interested in the video via more video information, and simplify the pattern of playing the video when users make sure they're interested, thereby greatly enhance the fluency for users to select and play the video.

It should be understood that both the foregoing general description and the details later in the description are exemplary and explanatory and does not limit the disclosure.

### BRIEF DESCRIPTION OF DRAWINGS

In order to more clearly illustrate the embodiments of the present disclosure, the drawings as required for illustrating the embodiments will be described in brief. Apparently, the drawings described below are merely some embodiments of the present disclosure, and for the ordinary skilled in the art can learn other drawings from the drawings without creative efforts.

FIG. 1 is a schematic flow diagram of a method for video playback according to some embodiments of the present disclosure.

FIG. 2 is a schematic flow diagram of a method for video playback according to some embodiments of the present disclosure.

FIG. 3 is a schematic view of an apparatus for video playback according to some embodiments of the present disclosure.

FIG. 4 is a schematic view showing the changes in the page before and after a light pressing a preview picture according to some embodiments of the present disclosure.

FIG. 5 is a schematic view showing the changes in the page before and after a light pressing is switched to a heavy pressing according to some embodiments of the present disclosure.

FIG. 6 is a schematic view showing the changes in the page before and after a light pressing is switched to a releasing according to some embodiments of the present disclosure.

By the above drawings, the embodiments of the present disclosure have been shown clearly and will be described hereinafter in more details. These drawings and description are not intent in any way to limit the scopes of the conception of the present disclosure, but to describe the concept of the present disclosure for the skilled in the art by reference to specific embodiments.

### DETAILED DESCRIPTION

The present disclosure is described more fully hereinafter with reference to the accompanying drawings so that the objects, technical solutions and advantages of the present disclosure will become clearer and more apparent.

It will be stated that, the terms “first”, “second” etc. used herein are to distinguish various elements or parameters with the same name for the convenience. The embodiments of the present disclosure should not be limited by these terms and the specific description of these terms for the embodiments would be omitted hereinafter.

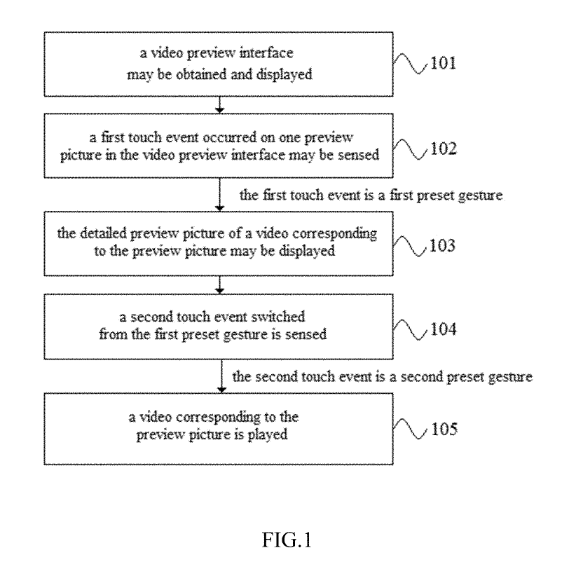

As shown in FIG. 1, a schematic flow diagram of a method for video playback according to some embodiments of the present disclosure is provided.

The method for video playback includes the following steps.

In step 101, a video preview interface 400 (see FIG. 4) may be obtained and displayed. Optionally, as shown in FIG. 4, the video preview interface 400 may include a plurality of the thumbnails of multiple preview pictures and each thumbnail of multiple preview pictures may have different size.

In step 102, a first touch event occurred on one preview picture 401 (i.e., one thumbnail in the video preview interface) in the video preview interface 400 may be sensed.

In step 103, the detailed preview picture 402 (see FIG. 4) of a video corresponding to the preview picture 401 may be displayed if the first touch event is a first preset gesture. Optionally, as shown in FIG. 4, the detailed preview picture 402 may be arranged such that the edges of both sides thereof are flush with the edges of both sides of the display region and may be arranged such that the preview picture may float above the video preview interface 400 as a new layer. In some embodiments, when the apparatus is placed horizontally, the video preview interface 400 and the detailed preview picture 402 may be similarly placed horizontally. The preview pictures in the video preview interface 400 may be placed horizontally following the same order. The edges of both sides of the detailed preview picture 402 may be flush with the edges of both sides of the display region (which are actually the upper and lower edges of the apparatus). In alternative embodiments, the upper and lower edges of the detailed preview picture may be flush with the upper and lower edges of the display region (which are actually the right and left side edges of the apparatus) according to the size of the preview pictures.

In step 104, a second touch event switched from the first preset gesture is sensed. In other words, the current touch event is switched immediately from the first preset gesture to the second touch event which is different from the first preset gesture.

In step 105, if the second touch event is a second preset gesture, a video corresponding to the preview picture (see FIG. 5) is played.

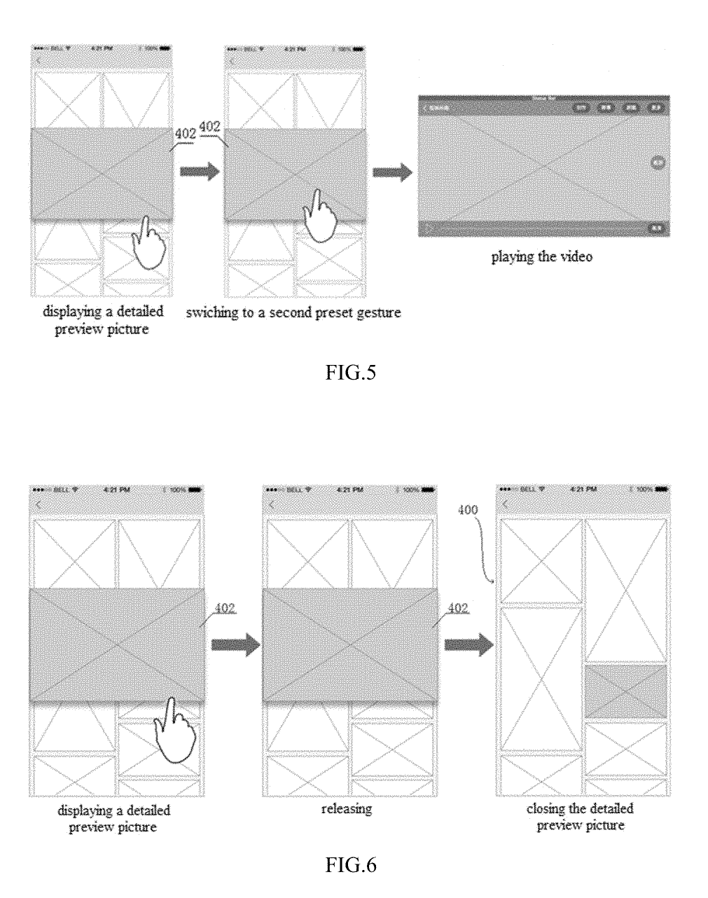

The detailed preview picture refers to a type of preview picture which contains richer and more comprehensive information than the displayed contents of the preview picture. Herein, in alternative embodiments, the detailed preview picture can be an enlarged picture of the preview picture, an enlarged video preview gif picture of the video corresponding to the preview picture, or an array of multiple preview pictures of key frames which are extracted by playing order of the video corresponding to the preview picture. In some embodiments, the display position and size of the detailed preview picture 402 shown in FIG. 4 (and FIG. 5 and FIG. 6) is suitable for an enlarged picture corresponding to the preview picture or an enlarged video preview gif picture of the video corresponding to the preview picture. In some embodiments, the array of multiple preview pictures of key frames which are extracted by playing order of the video corresponding to the preview picture is intended to occupy more interface area.

Among them, the enlarged picture refers to a picture which has larger size than the preview picture and higher resolution. Preferably, both side edges of the enlarged picture are flush with the edges of the screen. The video preview gif picture may be one highlight, a continuous stitching of a plurality of highlights, or a continuous stitching of a plurality of key frames of the preview picture of the video corresponding to the preview picture, which are established in a purpose of being able to show users the primary video content in the most intuitive way. Each picture has to be enlarged to the enlarged picture size and stitched while enlarged. The array of multiple preview picture can include 4, 6, or 9, etc., pieces of preview pictures and be arranged in an array. For example, if the array has 4 pictures, the pictures are arranged at upper left, lower left, upper right and lower right respectively in the array. If the array has 6 pictures, the pictures are arranged at upper left, middle left, lower left, upper right, middle right and lower right respectively in the array. If the array has 9 pictures, the pictures are arranged at upper left, middle left, lower left, upper middle, middle, lower middle, upper right, middle right and lower right respectively in the array. And the other arrangements can be achieved by referring to the above mentioned arrangements. Specifically, in the multiple preview pictures arranged in the array, the left edge of the leftmost preview picture and the right edge of the rightmost preview picture are flush with the both side edges of the display screen respectively. For displaying more contents, when the number of the multiple preview pictures is large (e.g., 9 pieces), the array can be arranged by a pattern of edges overlapping one by one, and when the number is small, the array can be arranged by a pattern of edges stitching each other.

As can be seen from the above, the method for video playback provided by the embodiments of the present disclosure, through applying a first preset gesture on the preview picture, enables users to view the detailed preview picture for more information about the video in order to determine whether users are interested in the video. When users make sure they're interested, users may switch to a second preset gesture from the first preset gesture to start playing the video directly. The method can allow the users to determine whether they are interested in the video via more video information, and simplify the pattern of playing the video when users make sure they're interested, thereby greatly enhance the fluency for users to select and play the video. Further, the detailed preview picture can be shown in a variety of ways, in which the display of the enlarged picture complies with common custom, and the gif picture is able to provide the user with more video contents so as to provide more video information with respect to the enlarged picture, so that the user can better determine whether it is the video of interest, and the multi-picture preview array is also able to provide more video information with respect to the enlarged picture, and occupy less space than the gif picture and has a faster response, so that it is more benefit for the user to use while achieving almost the same effects. All three ways have respective advantage and can be selected as required.

Preferably, the first preset gesture is a light pressing and the second preset gesture is a heavy pressing.

Herein, the terms “light pressing” and “heavy pressing” mean that the finger touches the screen and applies a pressure for a period of time (i.e. a second time interval in order to distinguish from the first time interval, a preset time data), wherein the touch with smaller pressure is the light pressing and the touch with greater pressure is the heavy pressing.

By setting the first preset gesture and second preset gesture as the light pressing and heavy pressing respectively, the user can implement the video playback via a continuous operations of light pressing and heavy pressing, so as to greatly simplify the operation steps of the user's video playback and improve the user's experience.

Optionally, in some embodiments, the method further comprises a step of distinguishing between the light pressing and the heavy pressing, wherein the step can include the following steps.

The touch pressure measured by the touch screen which has a pressure sensitive function may be compared with a preset first pressure threshold to determine whether the touch event is a light pressing or a heavy pressing. In other words, the touch event is a heavy pressing if the touch pressure is greater than the first pressure threshold. And the touch event is a light pressing if the touch pressure is less than or equal to the first pressure threshold.

Alternatively, the touch area (which herein only referring to finger) may be monitored by using the touch screen which can measure the touch area. During the first touch event, the touch event is a light pressing if the touch area between the finger and the touch screen is less than or equal to the first touch area threshold. And the touch event is a heavy pressing if the touch area between the finger and the touch screen is larger than the first touch area threshold.

Alternatively, the combination of the touch pressure and the touch area may be used for determining. For example, if the touch pressure is less than or equal to the first pressure threshold, and/or the touch area between the finger and the touch screen is less than or equal to the first touch area threshold, the touch is a light pressing. And if the touch pressure is greater than the first pressure threshold, and/or the touch area between the finger and the touch screen is larger than the first touch area threshold, then it is a heavy pressing.

The above-mentioned methods for distinguishing of light pressing from heavy pressing also can be directly implemented by the current terminal devices having 3D Touch Technology. Such as iPhone 6S, iPhone 6S plus, iPad pro and future devices having IOS9.0 and above operating system.

Optionally, some specific embodiments for implementing the Step 101 of obtaining and displaying the video preview interface may include the following steps.

A video list (which can be obtained according to the classifications such as the latest, the most popular, etc., if the interface is the main interface) may be obtained according to the selected items (such as entertainment, movies, etc.). A video ranking according to CTR (click to rate) or on-line date may be performed. The snapshots at every specified time point of each video may be extracted and sequentially arranged to form a video preview interface.

Of course, other embodiments may be implemented. It is unnecessary to apply any limitation to the acquisition of the video preview interface. And it only needs to acquire one video preview interface for subsequent operations.

Further, in some embodiments, if the detailed preview picture is the enlarged video preview gif picture of the video corresponding to the preview picture, after the Step 102 of sensing a first touch event occurred on one preview picture, the method also may include the following steps.

If the first touch event is tapping, the enlarged picture of the preview picture or the array of multiple preview pictures of key frames which are extracted by playing order of the video corresponding to the preview picture may be displayed.

The video preview interface may be displayed sequentially.

As used herein, the term “tapping” means that the finger touches the screen and applies a pressure for a transient time (far less than the second time interval), and the finger will release from the screen after the transient time.

Based on the above-discussed methods for distinguishing between a light pressing and a heavy pressing, in addition to detection of touch and release before and after the transient time, the optional embodiments for distinguishing between a tapping and a light pressing also may include the following steps.

A second pressure threshold may be set. If the touch pressure is greater than the second pressure threshold and less than the first pressure threshold, the touch event is a light pressing. If the touch pressure is less than or equal to the second pressure threshold, the touch event is a tapping.

Alternatively, a second touch area threshold may be set. During the first touch event, if the touch area between the finger and the touch screen is larger than the second touch area threshold and less than or equal to the first touch area threshold, the touch even is a light pressing. If the touch area between the finger and the touch screen is less than or equal to the second touch area threshold, the touch event is a tapping.

Alternatively, the combination of the touch pressure and the touch area may be used for determining. For example, if the touch pressure is less than or equal to the second pressure threshold, and/or the touch area between the finger and the touch screen is less than or equal to the second touch area threshold, the touch event is a tapping. If the touch pressure is greater than the second pressure threshold and less than or equal to the first pressure threshold, and/or the touch area between the finger and the touch screen is larger than the second touch area threshold and less than or equal to the first touch area threshold, the touch event is a light pressing.

The first time interval can be set by the maximum time requested for the user to obtain the enlarged picture of the preview picture or all the information of the array of multiple preview pictures of key frames which are extracted by playing order of the video corresponding to the preview picture, in order to ensure that the user can absorb all information provided by the enlarged picture of the preview picture or the array of multiple preview pictures of key frames which are extracted by playing order of the video corresponding to the preview picture to the greatest extent.

The above-described embodiments can make the user obtain a certain amount of information in the case of tapping, and also obtain more information in the case of light pressing than that in the case of tapping. The process of light pressing can have a data acquisition time, and it will be more reasonably designed for obtaining the gif picture.

Further, in other embodiments, after the step 104 of sensing a second touch event switched from the first preset gesture, the method may further include the following steps.

The detailed preview picture may be closed and the video preview interface may be displayed (see FIG. 6) if the second touch event is a releasing.

The detailed preview picture may be closed and the touched preview picture may be deleted from the video preview interface if the second touch event is a swiping to the left.

A preview picture of a new video may be extracted from other sources not shown in the video preview interface. The preview picture of the new video may be filled into the position of the deleted preview picture.

The new video preview interface may be displayed.

Herein, the term “releasing” means to detect a disappearance of the touch event (i.e., the touching finger is removed from the screen so that the touch screen cannot detect any touch signal). The term “swiping to the left” means that the occurring position of the touch point generates a displacement to the left.

In the above-described embodiments, when the user views the detailed preview picture via the action of light pressing and finds that the video is not the video of interest, he/she can quit the detailed preview picture by releasing the pressing finger and continue to look for other videos in the video preview interface. By the design of swiping to the left, the user can delete any video interested in based on his/her need and add new video into the video preview interface, so that more other video information can be acquired, and the wideness and effectiveness of user's video selection can be improved. Of course, the deleting gesture is designed as a swiping to the left mainly because it complies with the user's custom of deleting contents, so that it is not any limitation to the scope of the disclosure and the swiping direction or pattern can be modified as required.

Optionally, according to some embodiments, the Step 105 of playing the video corresponding to the preview picture may include the following steps.

The playback path of the corresponding video may be extracted according to the touched preview picture. A video player software may be opened. The video may be played by the video player software according to the playback path of the video.

Herein, a method of video playback is provided above for illustration of general methods of video playback according to some embodiments of the present disclosure. Of course, other methods may also be used to play the video without any limitation to the scope of the present disclosure.

Further, in a yet another embodiment, a logo for guiding the user to click on such position is provided at one of the four corners of each preview picture in the video preview interface. Optionally, the logo can be designed as circular, square, triangle and other geometric patterns, within which it can be marked as “Click Me” “Click” “Click Here” and other words, to guide the user click on the corner of the preview picture to view the detailed preview picture, so as to avoid the user's finger blocking the screen. Preferably, the logo can be designed based on the position of the preview picture on the video preview interface. For example, if the preview picture is located on the left or the upper left, the logo can be arranged on the upper left corner, or if the preview picture is located on the right or the upper right, the logo can be arranged on the upper right corner, or if the preview picture is located on the lower left or the lower right, the logo can be arranged on the lower left corner or lower right corner and so on. Similarly, the video preview interface having more number of preview pictures also can be arranged like this, so as to further avoid the user's finger blocking the screen.

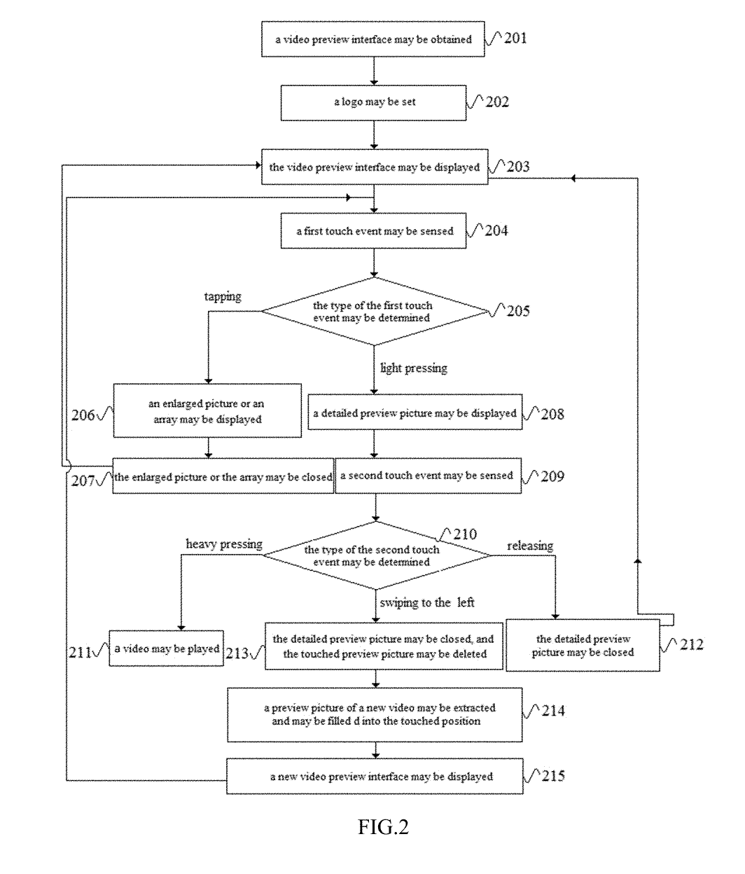

The present disclosure also provides another embodiment of a method for video playback. As shown in FIG. 2, it is a schematic flow diagram of a method for video playback according to another embodiment of the present disclosure.

The method for video playback can include the following steps.

Instep 201, a video preview interface may be obtained.

Instep 202, a logo may be set at one of the four corners of each preview picture in the video preview interface.

Instep 203, the video preview interface may be displayed.

Instep 204, a first touch event occurred on one preview picture in the video preview interface may be sensed.

Instep 205, the type of the first touch event may be determined. If it is a tapping, jumping to Step 206. If it is a light pressing, jumping to Step 208.

Instep 206, an enlarged picture of the preview picture or an array of multiple preview pictures of key frames which are extracted by playing order of the video corresponding to the preview picture may be displayed.

Instep 207, after a first time interval, the enlarged picture of the preview picture or the array of multiple preview pictures of key frames which are extracted by playing order of the video corresponding to the preview picture may be closed. And returning to Step 203.

Instep 208, a detailed preview picture of a video corresponding to the preview picture may be displayed.

Instep 209, a second touch event switched from the light pressing may be sensed.

Instep 210, the type of the second touch event may be determined. If it is a heavy pressing, jumping to Step 211. If it is a releasing, jumping to Step 212. If it is a swiping to the left, jumping to Step 213.

Instep 211, the video corresponding to the preview picture may be played.

Instep 212, the detailed preview picture may be closed, and returning to Step 203.

Instep 213, the detailed preview picture may be closed, and the corresponding touched preview picture may be deleted from the video preview interface.

Instep 214, a preview picture of a new video may be extracted from other video sources not shown in the video preview interface. The preview picture of the new video may be filled into the position of the deleted preview picture.

Instep 215, a new video preview interface may be displayed. The occurrence of the first touch event may be monitored sequentially.

As can be seen from the above, the method for video playback provided according to some embodiments of the present disclosure, through applying a first preset gesture on the preview picture, enables users to view the detailed preview picture for more information about the video in order to determine if they are interested in the video. When users make sure they're interested, user may switch to a second preset gesture from the first preset gesture to start playing the video directly. The method can allow the users to determine whether they are interested in the video via more video information, and simplify the pattern of playing the video after users make sure they're interested, thereby greatly enhance the fluency for users to select and play the video. In addition, the method also designs a logo at any corner of the preview picture to guide the user's touch action to occur within the area where the logo is, to avoid the user's hand blocking the display area and make the user better view the detailed preview picture.

It should be particularly noted that, the various steps of the method in the embodiments mentioned above can be appropriately combined, such as crossing each other, substitution, addition, deletion, and therefore these reasonable combinations of the method should be also fallen into the scope of the present disclosure and the scope of the disclosure should not be limited to the above-described embodiments.

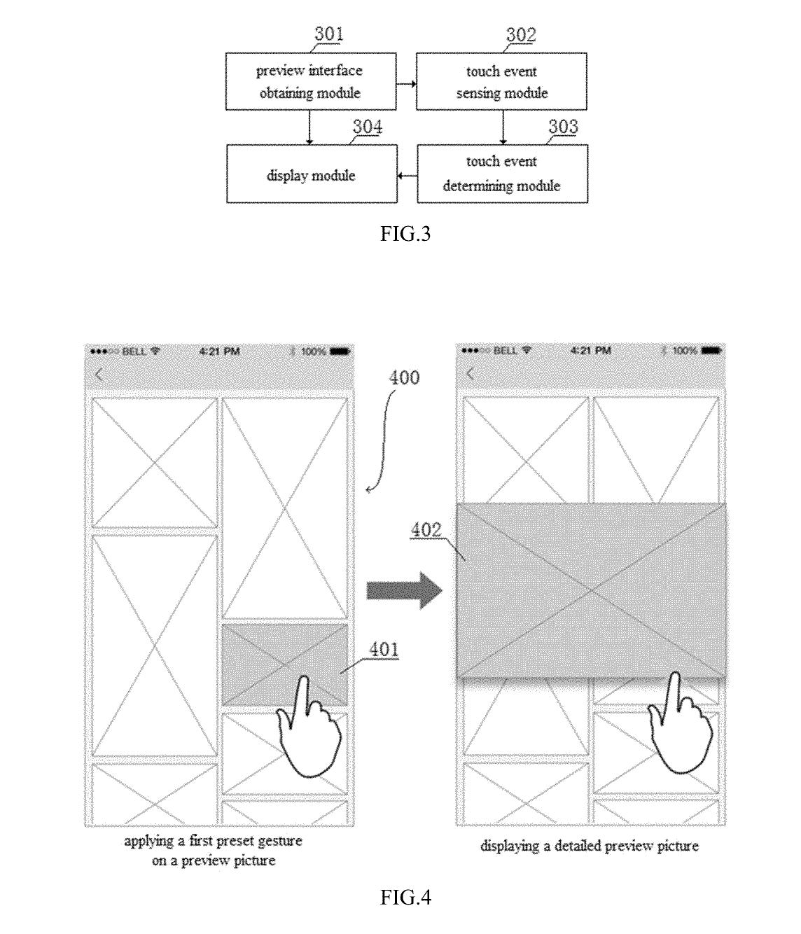

Another aspect of the present disclosure also provides an apparatus for video playback, as shown in FIG. 3, a schematic view of an apparatus for video playback according to some embodiments of the present disclosure is provided.

The apparatus for video playback includes:
a preview interface obtaining module 301, configured to obtain a video preview interface by a preview instruction;
a touch event sensing module 302, configured to sense the occurrence of a first touch event and a second touch event on one preview picture in the video preview interface;
a touch event determining module 303, configured to determine whether the first touch event is a first preset gesture, wherein if it is a first preset gesture, an instruction of displaying a detailed preview picture to the display module is sent, and configured to determining whether the second touch event is a second preset gesture, wherein if it is a second preset gesture, an instruction of playing video to the display module is sent; and
a display module 304, configured to display the video preview interface, the detailed preview picture or the video.

Preferably, the first preset gesture is a light pressing and the second preset gesture is a heavy pressing.

Herein, the terms “light pressing” and “heavy pressing” mean that the finger touches the screen and applies a pressure for a period of time (referred to as a second time interval in order to distinguish from the subsequent first time interval; the second time interval is a preset time data), wherein the touch with smaller pressure is the light pressing and the touch with greater pressure is the heavy pressing.

In an alternative embodiment, the touch event determining module 303 is further used for distinguishing between the pressures of the light pressing and the heavy pressing, including the following steps.

The touch pressure measured by the touch screen which has a pressure sensitive function may be compared with a preset first pressure threshold to determine whether the touch event is a light pressing or a heavy pressing. In other words, the touch event is a heavy pressing if the touch pressure is greater than the first pressure threshold. The touch event is a light pressing if the touch pressure is less than or equal to the first pressure threshold.

Alternatively, the touch area (which herein only referring to finger) may be monitored by using the touch screen which can measure the touch area. During the first touch event, the touch event is a light pressing if the touch area between the finger and the touch screen is less than or equal to the first touch area threshold. The touch event is a heavy pressing if the touch area between the finger and the touch screen is larger than the first touch area threshold.

Alternatively, the combination of the touch pressure and the touch area may be used for determining. For example, if the touch pressure is less than or equal to the first pressure threshold, and/or the touch area between the finger and the touch screen is less than or equal to the first touch area threshold, the touch is a light pressing. If the touch pressure is greater than the first pressure threshold, and/or the touch area between the finger and the touch screen is larger than the first touch area threshold, then it is a heavy pressing.

The above-mentioned methods for distinguishing of a light pressing from a heavy pressing also can be directly implemented by the current terminal devices having 3D Touch Technology, such as iPhone 6S, iPhone 6S plus, iPad pro and future devices having IOS9.0 and above operating system.

The detailed preview picture refers to a type of preview picture which contains richer and more comprehensive information than the displayed contents of the preview picture. Herein, in alternative embodiments of the detailed preview picture can be an enlarged picture of the preview picture, an enlarged video preview gif picture of the video corresponding to the preview picture, or an array of multiple preview pictures of key frames which are extracted by playing order of the video corresponding to the preview picture.

Among them, the enlarged picture refers to a picture which has larger size than the preview picture and higher resolution. Preferably, both side edges of the enlarged picture are flush with the edges of the screen; the video preview gif picture may be one highlight, a continuous stitching of a plurality of highlights, or a continuous stitching of a plurality of key frames of the preview picture of the video corresponding to the preview picture, which are established in a purpose of being able to show users the primary video content in the most intuitive way. Each picture has to be enlarged to the enlarged picture size and stitched while enlarged. The array of multiple preview picture can include 4, 6, or 9, etc., pieces of preview pictures and arranged in an array. For example, if the array has 4 pictures, the pictures are arranged at upper left, lower left, upper right and lower right respectively in the array. If the array has 6 pictures, the pictures are arranged at upper left, middle left, lower left, upper right, middle right and lower right respectively in the array. If the array has 9 pictures, the pictures are arranged at upper left, middle left, lower left, upper middle, middle, lower middle, upper right, middle right and lower right respectively in the array. And the other arrangements can be achieved by referring to the above mentioned arrangements. Specifically, in the multiple preview pictures arranged in the array, the left edge of the leftmost preview picture and the right edge of the rightmost preview picture are flush with the both side edges of the display screen respectively. For displaying more contents, when the number of the multiple preview pictures is large (e.g., 9 pieces), the array can be arranged by a pattern of edges overlapping one by one, and when the number is small, the array can be arranged by a pattern of edges stitching each other.

As can be seen from the above, the apparatus for video playback provided by the embodiments of the present disclosure, through applying a first preset gesture on the preview picture, enables users to view the detailed preview picture for more information about the video in order to determine whether users are interested in the video. When users make sure they're interested, users may switch to a second preset gesture from the first preset gesture to start playing the video directly. The method can allow the users to determine whether they are interested in the video via more video information, and simplify the pattern of playing the video when users make sure they're interested, thereby greatly enhance the fluency for users to select and play the video. Further, the detailed preview picture can be shown in a variety of ways, in which the display of the enlarged picture complies with common custom, and the gif picture is able to provide the user with more video contents so as to provide more video information with respect to the enlarged picture, so that the user can better determine whether it is the video of interest, and the multi-picture preview array is also able to provide more video information with respect to the enlarged picture, and occupy less space than the gif picture and has a faster response, so that it is more benefit for the user to use while achieving almost the same effects. All three ways have respective advantage and can be selected as required.

Optionally, the preview interface obtaining module 301 further can be configured to do the following steps.

A video list (which can be obtained according to the classifications such as the latest, the most popular, etc., if the interface is the main interface) may be obtained according to the selected items (such as entertainment, movies, etc.). A video ranking according to CTR (click to rate) or on-line date may be performed. The snapshots at every specified time point of each video may be extracted and sequentially arranged to form a video preview interface.

Of course, other embodiments may be implemented. It is unnecessary to apply any limitation to the acquisition of the video preview interface. And it only needs to acquire one video preview interface for subsequent operations.

Further, in another embodiment, if the detailed preview picture is the enlarged video preview gif picture of the video corresponding to the preview picture, then the touch event determining module 303 further can be configured to determine whether the first touch event is a tapping. If it is a tapping, then an enlarged picture preview instruction or array preview instruction is sent to the display module 304.

The display module 304 can be further used for displaying the enlarged picture of the preview picture or the array of multiple preview pictures of key frames which are extracted by playing order of the video corresponding to the preview picture according to the enlarged picture preview instruction or array preview instruction; and after the first time interval, closing the enlarged picture of the preview picture or the array of multiple preview pictures of key frames which are extracted by playing order of the video corresponding to the preview picture; and continuing to display the video preview interface.

As used herein, the term “tapping” means that the finger touches the screen and applies a pressure for a transient time (far less than the second time interval), and the finger will release from the screen after the transient time.

Based on the above-discussed methods for distinguishing between light pressing and heavy pressing, in addition to detection of touch and release before and after the transient time, the touch event determining module 303 further can be configured to distinguish between a tapping and a light pressing, including the following steps.

A second pressure threshold may be set. If the touch pressure is greater than the second pressure threshold and less than the first pressure threshold, the touch event is a light pressing. If the touch pressure is less than or equal to the second pressure threshold, the touch event is a tapping.

Alternatively, a second touch area threshold may be set. During the first touch event, if the touch area between the finger and the touch screen is larger than the second touch area threshold and less than or equal to the first touch area threshold, the touch even is a light pressing. If the touch area between the finger and the touch screen is less than or equal to the second touch area threshold, the touch event is a tapping.

Alternatively, the combination of the touch pressure and the touch area may be used for determining. For example, if the touch pressure is less than or equal to the second pressure threshold, and/or the touch area between the finger and the touch screen is less than or equal to the second touch area threshold, the touch event is a tapping. If the touch pressure is greater than the second pressure threshold and less than or equal to the first pressure threshold, and/or the touch area between the finger and the touch screen is larger than the second touch area threshold and less than or equal to the first touch area threshold, the touch event is a light pressing.

The first time interval can be set by the maximum time requested for the user to obtain the enlarged picture of the preview picture or all the information of the array of multiple preview pictures of key frames which are extracted by playing order of the video corresponding to the preview picture, in order to ensure that the user can absorb all information provided by the enlarged picture of the preview picture or the array of multiple preview pictures of key frames which are extracted by playing order of the video corresponding to the preview picture to the greatest extent.

The above-described embodiments can make the user obtain a certain amount of information in the case of tapping, and also obtain more information in the case of light pressing than that in the case of tapping. The process of light pressing can have a data acquisition time, and it will be more reasonably designed for obtaining the gif picture.

Further, in another embodiment, the touch event determining module 303 further can be configured to determine whether the second touch event is a releasing. If it is a releasing, the touch event determining module 303 can be configured to send a closing detailed preview picture instruction to the display module 304. The display module 304 further can be configured to close the detailed preview picture and display the video preview interface, according to the closing detailed preview picture instruction.

Further, in yet another preferred embodiment, the touch event determining module 303 further can be configured to determine whether the second touch event is a swiping to the left. If it is a swiping to the left, the touch event determining module 303 can be configured to send a deleting preview picture instruction to the display module 304. The display module 304 further can be configured to extract a preview picture of a new video from other video sources not shown in the video preview interface and fill the preview picture of the new video into the position of the deleted preview picture; and display the new video preview interface, according to the deleting preview picture instruction.

Herein, the term “releasing” means to detect a disappearance of the touch event (i.e., the touching finger is removed from the screen so that the touch screen cannot detect any touch signal). The term “swiping to the left” means that the occurring position of the touch point generates a displacement to the left.

In the above-described embodiments, when the user views the detailed preview picture via the action of light pressing and finds that the video is not the video of interest, he/she can quit the detailed preview picture by releasing the pressing finger and continue to look for the other videos in the video preview interface. By the design of swiping to the left, the user can delete any video interested in based on her/his need and add new video into the video preview interface, so that more other video information can be acquired, and the wideness and effectiveness of user's video selection can be improved. Of course, the deleting gesture is designed as a swiping to the left mainly because it complies with the user's custom of deleting contents, so that it is not any limitation to the scope of the disclosure and the swiping direction or pattern can be modified as required.

Optionally, one embodiment of the display module 304 playing the video corresponding to the preview picture may include the following steps.

The playback path of the corresponding video may be extracted according to the touched preview picture. A video player software may be opened. The video may be played by the video player software according to the playback path of the video.

Herein, the above mentioned embodiments is merely an optional embodiment for playing the video for the purpose of illustration of a general method of video playback. Of course, other methods may also be used to play the video without any limitation to the scope of the present disclosure.

Further, in a yet another embodiment, a logo for guiding the user to click on such position is provided at one of the four corners of each preview picture in the video preview interface. Optionally, the logo can be designed as circular, square, triangle and other geometric patterns, within which it can be marked as “Click Me” “Click” “Click Here” and other words, to guide the user click on the corner of the preview picture to view the detailed preview picture, so as to avoid the user's finger blocking the screen. Preferably, the logo can be designed based on the position of the preview picture on the video preview interface. For example, if the preview picture is located on the left or the upper left, the logo can be arranged on the upper left corner, or if the preview picture is located on the right or the upper right, the logo can be arranged on the upper right corner, or if the preview picture is located on the lower left or the lower right, the logo can be arranged on the lower left corner or lower right corner and so on. Similarly, the video preview interface having more numbers of preview pictures also can be arranged like this, so as to further avoid the user's finger blocking the screen.

Now in combination with an embodiment of the method for video playback in the present disclosure, herein provides an example of how the apparatus for video playback according to some embodiments of the present disclosure to implements the method for video playback according to some embodiments of the present disclosure. As shown in FIG. 2, herein provides a schematic flow diagram of a method for video playback according to another embodiment of the present disclosure.

The method for video playback can include the following steps.

Instep 201, the preview interface obtaining module 301 obtains a video preview interface.

Instep 202, the preview interface obtaining module 301 sets a logo at one of the four corners of each preview picture in the video preview interface.

Instep 203, the display module 304 displays the video preview interface.

Instep 204, the touch event sensing module 302 senses a first touch event occurred on one preview picture in the video preview interface.

Instep 205, the touch event determining module 303 determines the type of the first touch event. If it is a tapping, then jumping to Step 206; and if it is a light pressing, then jumping to Step 208.

Instep 206, the display module 304 displays an enlarged picture of the preview picture or an array of multiple preview pictures of key frames which are extracted by playing order of the video corresponding to the preview picture.

Instep 207, after a first time interval, the display module 304 closes the enlarged picture of the preview picture or the array of multiple preview pictures of key frames which are extracted by playing order of the video corresponding to the preview picture. And returning to Step 203.

Instep 208, the display module 304 displays a detailed preview picture of the video corresponding to the preview picture.

Instep 209, the touch event sensing module 302 senses a second touch event switched from the light pressing.

Instep 210, the touch event determining module 303 determines the type of the second touch event. If it is a heavy pressing, then jumping to Step 211; if it is releasing, then jumping to Step 212; and if it is swiping to the left, then jumping to Step 213.

Instep 211, the display module 304 plays the video corresponding to the preview picture.

Instep 212, the display module 304 closes the detailed preview picture. And returning to Step 203.

Instep 213, the display module 304 closes the detailed preview picture and deletes the corresponding touched preview picture from the video preview interface.

Instep 214, the display module 304 extracts a preview picture of a new video from other video sources not shown in the video preview interface and fills the preview picture of the new video into the position of the deleted preview picture.

Instep 215, the display module 304 displays a new video preview interface and continues to monitor the occurrence of a first touch event.

In addition to the implementing embodiment that each module processes the respective procedure, all the data processing steps of each module in the apparatus embodiment can be executed by a CPU which also can distribute the processed data, or each module can include respective micro-processor and transmit the data by the CPU. Furthermore, the preview interface obtaining module 301 may also be integrated into the display module 304 to form a touch screen device having a processing function. The touch event sensing module 302 may also be integrated into the touch screen device to sense the touch events by the touch screen device. The touch event determining module 303 may be integrated into the CPU to primarily execute the touch event determining steps. Of course, these are merely exemplary to provide some module design embodiments of the apparatus, and the scope of the present disclosure is not limited thereto. The skilled in the art can also obtain other embodiments by modification and transformation of the proposed embodiments.

Yet another aspect of the present disclosure also provides an apparatus, wherein one embodiment of the apparatus can comprise:
a touch screen, configured to receive a touch signal;
one or more processor(s); and
a memory, configured to store one or more operating instruction(s);

wherein the one or more processor(s) is/are configured to obtain operation instruction from the memory and execute(s) the steps of:
obtaining and displaying a video preview interface;
sensing a first touch event occurred on one preview picture in the video preview interface;
displaying a detailed preview picture of the video corresponding to the preview picture if the first touch event is the first preset gesture;
sensing a second touch event switched from the first preset gesture; and
playing a video corresponding to the preview picture if the second touch event is the second preset gesture.

In some embodiments, the first preset gesture is a light pressing and the second preset gesture is a heavy pressing.

Preferably, in some embodiments, the processor is further configured to execute the steps of:
setting a first pressure threshold such that if the touch pressure is greater than the first pressure threshold, the touch event is a heavy pressing, and such that if the touch pressure is less than or equal to the first touch pressure threshold, the touch event is a light pressing; or
setting a first touch area threshold, such that during the first touch event, if the touch area is less than or equal to the first touch area threshold, the touch event is a light pressing, and such that if the touch area is larger than the first touch area threshold, the touch event is a heavy pressing; or
determining based on the combination of the touch pressure and the touch area such that if the touch pressure is less than or equal to the first pressure threshold, and/or the touch area is less than or equal to the first touch area threshold, the touch event is a light pressing, and such that if the touch pressure is greater than the first pressure threshold, and/or the touch area is larger than the first touch area threshold, the touch event is a heavy pressing.

Preferably, in some embodiments, the processor is further configured to execute the steps of:
closing the detailed preview picture and displaying the video preview interface if the second touch event is a releasing.

In some embodiments, the processor is further configured to execute the steps of:
closing the detailed preview picture and deleting the touched preview picture in the video preview interface if the second touch event is a swiping to the left;
extracting a preview picture of a new video from other video sources not shown in the video preview interface and filling the preview picture of the new video into the position of the deleted preview picture; and
displaying the new video preview interface.

Preferably, in some embodiments, the detailed preview picture is the enlarged picture corresponding to the preview picture, an enlarged video preview gif picture of the video corresponding to the preview picture, or an array of multiple preview pictures of key frames which are extracted by playing order of the video corresponding to the preview picture.

Preferably, in some embodiments, the processor is further configured to execute the steps of:
displaying the enlarged picture of the preview picture or the array of multiple preview pictures of key frames which are extracted by playing order of the video corresponding to the preview picture if the first touch event is a tapping;
after a first time interval, closing the enlarged picture of the preview picture or the array of multiple preview pictures of key frames which are extracted by playing order of the video corresponding to the preview picture; and
continuing to display the video preview interface.

Preferably, in some embodiments, the processor is further configured to execute the steps of:
setting a second pressure threshold such that if the touch pressure is greater than the second pressure threshold and less than the first pressure threshold, the touch event is determined as a light pressing, and such that if the touch pressure is less than or equal to the second pressure threshold, the touch event is determined as tapping; or
setting a second touch area threshold, such that during the first touch event, if the touch area is larger than the second touch area threshold and less than or equal to the first touch area threshold, the touch event is determined as a light pressing, and such that if the touch area is less than or equal to the second touch area threshold, the touch event is determined as a tapping; or
determining based on the combination of the touch pressure and the touch area, such that if the touch pressure is less than or equal to the second pressure threshold, and/or the touch area is less than or equal to the second touch area threshold, the touch event is determined as tapping, and such that if the touch pressure is greater than the second pressure threshold and less than or equal to the first pressure threshold, and/or the touch area is larger than the second touch area threshold and less than or equal to the first touch area threshold, then the touch event is determined as light pressing.

Preferably, in some embodiments, a logo for guiding the user to click on this position is provided at one of the four corners of each preview picture in the video preview interface.

It should be specifically noted that the apparatus examples merely employ the method examples to specifically describe the processes of each module. The skilled in the art can easily consider to apply these modules into the other method embodiments. Obviously, since each step of the method embodiments can be crossed each other, substituted, added and deleted, the reasonable combinations for the apparatus should be fallen into the scope of the present disclosure, and the scope of the present disclosure should not be limited within these embodiments.

In addition, typically, the apparatus of the present disclosure can be a variety of electronic terminal devices such as mobile phone, personal digital assistant (PDA), tablet PC (PAD), smart TV, etc., so that the scope of the disclosure should not be limited to a specific type of electronic device. The system of the present disclosure can be applied in any one of the above electronic terminal device in the form of electronic hardware, computer software or a combination thereof.

Furthermore, the method according to the present disclosure may also be implemented as a computer program executed by CPU, and the computer program may be stored in a computer-readable storage medium. When the computer program is executed by CPU, the above functions defined in the methods of the present disclosure are executed.

Furthermore, the above-described method steps and system units can also be implemented by using a controller and a computer-readable storage medium for storing a computer program to make the controller to implement the above steps or unit functions.

Additionally, it should be appreciated that the computer-readable storage medium as described herein (for example, memory) may be volatile memory or nonvolatile memory, or can include both volatile memory and nonvolatile memory. As an example without any limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM) which can act as external cache RAM memory. As an example without any limitation, RAM is available in many forms, such as synchronous RAM (DRAM), dynamic RAM (DRAM), synchronous DRAM (SDRAM), double data rate SDRAM (DDR SDRAM), enhanced SDRAM (ESDRAM), sync link DRAM (SLDRAM) and direct RambusRAM (DRRAM). The disclosed aspects of the storage devices are intended to include, but not limited to these and other suitable types of memory.

Those skilled in the art will also understand that a combination of the illustrative logical blocks, modules, circuits, and algorithm steps described in this disclosure may be implemented as electronic hardware, computer software, or both. To clearly illustrate the interchangeability between hardware and software, various illustrative components, blocks, modules, circuits, and functions of steps have been generally described. Whether such function is implemented as software or hardware is depended on the particular application and the design constraints imposed on the whole system. Those skilled in the art can achieve the functions for each particular application in various ways, but such implementing decisions should not be interpreted as a departure from the scope of the present disclosure.

A combination of the illustrative logical blocks, modules, and circuits can be implemented or executed by using the following components designed to perform the functions described herein: general purpose processor (GPP), digital signal processor (DSP), dedicated integrated circuit (ASIC), field programmable gate array (FPGA) or other programmable logic device, discrete gate or transistor logic, discrete hardware components or any combination thereof. The GPP may be a microprocessor, but in the alternative, the processor may be any conventional processor, controller, microcontroller, or state machine. The processor may also be implemented as a combination of computing devices, e.g., a combination of DSP and microprocessor, a plurality of microprocessors, one or more microprocessor(s) with a DSP core, or any other such configuration.

A combination of the steps of method or algorithm described herein may be contained directly in hardware, software module executed by a processor, or both. The software module may reside in RAM memory, flash memory, ROM memory, EPROM memory, EEPROM memory, registers, hard disk, removable disk, CD-ROM known in the art or any other form of storage medium. An exemplary storage medium is coupled to the processor such that the processor can read information from the storage medium or write information to the storage medium. Alternatively, the storage medium may be integrated into the processor. The processor and the storage medium may reside in ASIC. ASIC may reside in a user terminal. In one alternative, the processor and the storage medium may reside as discrete components in a user terminal.

In one or more exemplary designs, the functions described herein may be implemented in hardware, software, firmware, or any combination thereof. If implemented in software, the functions may be transmitted as one or more instructions or codes stored on a computer readable medium or by a computer-readable medium. Computer-readable medium includes both computer storage medium and communication medium, and the communication medium includes any medium contributed to transmit a computer program from one place to another. The storage medium may be any available medium accessible by a general purpose or special purpose computer. As an example without any restriction, the computer-readable medium can comprise RAM, ROM, EEPROM, CD-ROM or other optical disk storage, magnetic disk storage or other magnetic storage devices, or can be any other medium for carrying or storing the desired program codes in the form of instruction or data structures and can be accessed by or via a general purpose or special purpose computer. Also, any connection can be properly termed as a computer-readable medium. For example, if using a coaxial cable, fiber optic cable, twisted pair, digital subscriber line (DSL) or wireless technologies such as infrared, radio, and microwave to transmit software from website, server, or other remote source, the coaxial cable, fiber optic cable, twisted pair, DSL, or wireless technologies such as infrared, radio, and microwave are included in the definition of medium. As used herein, the terms of disk and disc include CD-ROM disc (CD), laser disc, optical disc, digital versatile disc (DVD), floppy disk and blue-ray disc where the disk usually reproduces data magnetically and the disc reproduces data optically with lasers. Combinations of the above should also be included within the scope of computer-readable medium.

It should be understood that various changes and modifications may be made to the exemplary embodiments disclosed herein, without departing from the scopes of the disclosure defined in the appended claims. The functions, steps and/or actions of the method claims disclosed herein do not have to be executed in any particular order. Furthermore, although elements of the present disclosure may be described or claimed as an individual form, but a plurality can also be envisaged unless explicitly restricted to single.

It should be understood that, as used herein, unless the context clearly supports exceptions, the singular forms “a” (“a”, “an”, “the”) is intended to include the plural forms. It should also be understood that “and/or” used herein is intended to include any and all possible combinations of one or more of the associated listed items.

The serial number of the embodiments herein is merely used for illustration without representing the merits of the embodiments.

Those ordinary skilled in the art will appreciate that all or part of the steps to achieve the above-described embodiments may be accomplished by hardware or by instructing relevant hardware via program, and the program may be stored in a computer readable storage medium such as read-only memory, magnetic disk or optical disc.

Those ordinary skilled in the art will appreciate that any of the embodiments discussed are exemplary only without intended to imply that the scopes of the present disclosure (including claims) are limited to these examples; the embodiments or the features in the different embodiments may be combined and the steps may be implemented in any order in accordance with the idea of the present disclosure, and there are many other variations of the different aspects of the present disclosure as described herein without description in the details for simplicity. Thus, any omissions, modifications, equivalent replacements and improvements made in the spirit and principles of the present disclosure should be included within the scopes of the present disclosure.

What is claimed is:

1. A method for video playback, comprising:
obtaining and displaying a video preview interface;
sensing a first touch event occurred on one preview picture in the video preview interface;
displaying a detailed preview picture of a video corresponding to the preview picture if the first touch event is a first preset gesture;
sensing a second touch event switched from the first preset gesture; and
playing the video corresponding to the preview picture if the second touch event is a second preset gesture.

2. The method according to claim 1, wherein the first preset gesture is a light pressing and the second preset gesture is a heavy pressing.

3. The method according to claim 2, further comprising a step of distinguishing between the light pressing and the heavy pressing, wherein the step comprises:
setting a first pressure threshold, such that the touch event is determined as the heavy pressing if a touch pressure is greater than the first pressure threshold, and such that the touch event is determined as the light pressing if a touch pressure is less than or equal to the first pressure threshold; or
setting a first touch area threshold, such that the touch event is determined as the light pressing if a touch area is less than or equal to the first touch area threshold, and such that the touch event is determined as the heavy pressing if a touch area is larger than the first touch area threshold; or
determining based on the combination of the touch pressure and the touch area, such that if the touch pressure is less than or equal to the first pressure threshold, and/or the touch area is less than or equal to the first touch area threshold, the touch event is determined as the light pressing; and such that if the touch pressure is greater than the first pressure threshold, and/or the touch area is larger than the first touch area threshold, the touch event is determined as the heavy pressing.

4. The method according to claim 1, wherein after sensing a second touch event switched from the first preset gesture, the method further comprises:
closing the detailed preview picture and displaying the video preview interface if the second touch event is a releasing.

5. The method according to claim 1, wherein after sensing a second touch event switched from the first preset gesture, the method further comprises:
closing the detailed preview picture and deleting the touched preview picture from the video preview interface if the second touch event is a swiping to the left; and
extracting a preview picture of a new video from video sources not shown in the video preview interface and filling the preview picture of the new video into the position of the deleted preview picture.

6. The method according to claim 2, wherein the detailed preview picture is an enlarged picture of the preview picture, an enlarged video preview gif picture of the video corresponding to the preview picture, or an array of multiple preview pictures of key frames which are extracted by playing order of the video corresponding to the preview picture.

7. The method according to claim 6, wherein after sensing a first touch event occurred on one preview picture in the video preview interface, the method further comprises:
displaying the enlarged picture of the preview picture or the array of multiple preview pictures of key frames which are extracted by playing order of the video corresponding to the preview picture if the first touch event is a tapping; and
after a first time interval, closing the enlarged picture of the preview picture or the array of multiple preview pictures of key frames which are extracted by playing order of the video corresponding to the preview picture

8. The method according to claim 7, further comprising a step of distinguishing between the light pressing and the tapping, wherein the step comprises:
setting a second pressure threshold, such that the touch event is determined as the light pressing if the touch pressure is greater than the second pressure threshold and less than the first pressure threshold, and such that the touch event is determined as the tapping if the touch pressure is less than or equal to the second pressure threshold; or
setting a second touch area threshold, such that the touch event is determined as the light pressing if a touch area is larger than the second touch area threshold and less than or equal to the first touch area threshold, and such that the touch event is determined as the tapping if the touch area is less than or equal to the second touch area threshold; or
determining based on the combination of the touch pressure and the touch area, such that if the touch pressure is less than or equal to the second pressure threshold, and/or the touch area is less than or equal to the second touch area threshold, the touch event is determined as the tapping, and such that if the touch pressure is greater than the second pressure threshold and less than or equal to the first pressure threshold, and/or the touch area is larger than the second touch area threshold and less than or equal to the first touch area threshold, the touch event is determined as the light pressing.

9. The method according to claim 1, wherein a logo for guiding the user to click on such position is provided at one of the four corners of each preview picture in the video preview interface.

10. An apparatus, comprising:
a touch screen, configured to receive a touch signal;
one or more processor(s); and
a memory, configured to store one or more operating instruction(s);
wherein the one or more processor(s) is/are configured to obtain operation instruction from the memory and execute(s) the steps of:
obtaining and displaying a video preview interface;
sensing a first touch event occurred on one preview picture in the video preview interface;
displaying a detailed preview picture of the video corresponding to the preview picture if the first touch event is the first preset gesture;
sensing a second touch event switched from the first preset gesture; and
playing a video corresponding to the preview picture if the second touch event is a second preset gesture.

11. The apparatus according to claim 10, wherein the first preset gesture is a light pressing and the second preset gesture is a heavy pressing.

12. The apparatus according to claim 11, wherein the processor is further configured to execute the steps of:
setting a first pressure threshold, such that the touch event is determined as the heavy pressing if the touch pressure is greater than the first pressure threshold, and such that the touch event is determined as the light pressing if the touch pressure is less than or equal to the first touch pressure threshold; or
setting a first touch area threshold, such that the touch event is determined as the light pressing if the touch area is less than or equal to the first touch area threshold, and such that the touch event is determined as the heavy pressing if the touch area is larger than the first touch area threshold; or
determining based on the combination of the touch pressure and the touch area, such that if the touch pressure is less than or equal to the first pressure threshold, and/or the touch area is less than or equal to the first touch area threshold, the touch event is determined as the light pressing, and such that if the touch pressure is greater than the first pressure threshold, and/or the touch area is larger than the first touch area threshold, the touch event is determined as the heavy pressing.

13. The apparatus according to claim 10, wherein the processor is further configured to execute the steps of:
closing the detailed preview picture and displaying the video preview interface if the second touch event is a releasing.

14. The apparatus according to claim 10, wherein the processor is further configured to execute the steps of:
closing the detailed preview picture and deleting the touched preview picture from the video preview interface if the second touch event is a swiping to the left; and
extracting a preview picture of a new video from video sources not shown in the video preview interface and filling the preview picture of the new video into the position of the deleted preview picture.

15. The apparatus according to claim 11, wherein the detailed preview picture is an enlarged picture of the preview picture, an enlarged video preview gif picture of the video corresponding to the preview picture, or an array of multiple preview pictures of key frames which are extracted by playing order of the video corresponding to the preview picture.

16. The apparatus according to claim 15, wherein the processor is further configured to execute the steps of:
displaying the enlarged picture of the preview picture or the array of multiple preview pictures of key frames which are extracted by playing order of the video corresponding to the preview picture if the first touch event is tapping; and
after a first time interval, closing the enlarged picture of the preview picture or the array of multiple preview pictures of key frames which are extracted by playing order of the video corresponding to the preview picture.

17. The apparatus according to claim 16, where in the processor is further configured to execute the steps of:
setting a second pressure threshold, such that the touch event is determined as the light pressing if the touch pressure is greater than the second pressure threshold and less than the first pressure threshold, and such that the touch event is determined as the tapping if the touch pressure is less than or equal to the second pressure threshold; or
setting a second touch area threshold, such that the touch event is determined as the light pressing if the touch area is larger than the second touch area threshold and less than or equal to the first touch area threshold, and such that the touch event is determined as the tapping if the touch area is less than or equal to the second touch area threshold; or
determining based on the combination of the touch pressure and the touch area, such that if the touch pressure is less than or equal to the second pressure threshold, and/or the touch area is less than or equal to the second touch area threshold, the touch event is determined as the tapping, and such that if the touch pressure is greater than the second pressure threshold and less than or equal to the first pressure threshold, and/or the touch area is larger than the second touch area threshold and less than or equal to the first touch area threshold, the touch event is determined as the light pressing.

18. The apparatus according to claim 10, wherein a logo for guiding the user to click on such position is provided at one of the four corners of each preview picture in the video preview interface.
